(19) United States
(12) Patent Application Publication
(10) Pub. No.: US 2021/0133505 A1
(43) Pub. Date: May 6, 2021

(54) METHOD, DEVICE, AND STORAGE MEDIUM FOR RETRIEVING SAMPLES

(71) Applicant: SHENZHEN SENSETIME TECHNOLOGY CO., LTD., Shenzhen (CN)

(72) Inventors: Lipeng WANG, Shenzhen (CN); Weihao TAN, Shenzhen (CN); Songgao YE, Shenzhen (CN); Shengen YAN, Shenzhen (CN)

(21) Appl. No.: 17/060,539

(22) Filed: Oct. 1, 2020

Related U.S. Application Data
(63) Continuation of application No. PCT/CN2020/098576, filed on Jun. 28, 2020.

(30) Foreign Application Priority Data
Oct. 31, 2019 (CN) 201911053934.0

(51) Int. Cl. G06K 9/62; G06F 12/0817; G06F 12/0891; G06F 12/02

(52) U.S. Cl. CPC G06K 9/6257; G06K 9/6219; G06F 12/0246; G06F 12/0891; G06F 12/0824

(57) ABSTRACT

The present disclosure relates to a method, apparatus, device, storage medium, and program for retrieving samples. The method comprises: shuffling a plurality of data blocks in a dataset, wherein each of the plurality of data blocks includes a plurality of samples; dividing the shuffled plurality of data blocks into a plurality of processing batches; shuffling a plurality of samples in a first processing batch among the plurality of processing batches, and obtaining a sample retrieving order corresponding to the first processing batch; and retrieving samples in the sample retrieving order corresponding to the first processing batch, for the first processing batch.

### CROSS-REFERENCE TO RELATED APPLICATION

This application is a continuation of and claims priority to PCT Application No. PCT/CN2020/098576, filed on Jun. 28, 2020, which claims priority to Chinese Patent Application No. 201911053934.0, filed on Oct. 31, 2019, titled “METHOD AND APPARATUS FOR RETRIEVING SAMPLES, ELECTRONIC DEVICE, AND STORAGE MEDIUM”. All the above-referenced priority documents are incorporated herein by reference in their entirety.

### TECHNICAL FIELD

The present disclosure relates to the field of computer technologies, and in particular, to a method, apparatus, device, storage medium, and program for retrieving samples.

### BACKGROUND

In deep learning, if the order of samples employed in each model training is the same, the resultant model will become overfitted. Therefore, it is necessary to shuffle the samples in the dataset every time before training is performed.

### SUMMARY

The present disclosure provides a method, apparatus, device, storage medium, and program for retrieving samples.

A first aspect of the present disclosure provides a method for retrieving samples, the method comprising:

shuffling a plurality of data blocks in a dataset, wherein each of the plurality of data blocks includes a plurality of samples;

dividing the shuffled plurality of data blocks into a plurality of processing batches;

shuffling a plurality of samples in a first processing batch among the plurality of processing batches, and obtaining a sample retrieving order corresponding to the first processing batch; and

retrieving samples in the sample retrieving order corresponding to the first processing batch, for the first processing batch.

In a possible implementation of the first aspect, the method further comprises, before retrieving samples;

retrieving a data block to which the samples belong from a distributed system and storing the data block in a local cache.

In this way, it is possible to reduce the number of times a data block is retrieved from the distributed system, reduce data access costs, and improve data reading efficiency.

In a possible implementation of the first aspect, retrieving samples in the sample retrieving order corresponding to the first processing batch comprises:

retrieving samples a plurality of times in the sample retrieving order corresponding to the first processing batch, wherein one or a plurality of samples are retrieved at a time, and a plurality of samples retrieved at a time belong to the same data block.

In this way, it is possible to retrieve a plurality of samples belonging to the same data block at a time from the same data block and thereby improve data retrieving efficiency.

In a possible implementation of the first aspect, retrieving samples a plurality of times in the sample retrieving order corresponding to the first processing batch comprises:

determining a target sample among a plurality of samples to be retrieved, in the sample retrieving order corresponding to the first processing batch, wherein the target sample is one sample to be retrieved this time; and

reading the target sample from the local cache.

In this way, it is possible to reduce the number of times a data block is retrieved from the distributed system, reduce data access costs, and improve data reading efficiency.

In a possible implementation of the first aspect, the method further comprises, after reading the target sample from the local cache:

reading, from the local cache, a sample among the plurality of samples to be retrieved that belongs to the same data block as the target sample.

In this way, it is possible to retrieve a plurality of samples belonging to the same data block from the same data block at a time and thereby improve data retrieving efficiency.

In a possible implementation of the first aspect, reading the target sample from the local cache comprises:

searching for a target data block corresponding to the target sample in the local cache based on a mapping between an identifier of the target sample and an identifier of a data block to which the target sample belongs, and reading the target sample from the target data block.

It is possible to quickly find a target data block corresponding to the target sample based on a mapping between an identifier of the target sample and an identifier of the data block to which the target sample belongs, and data retrieving efficiency can be improved.

In a possible implementation of the first aspect, reading the target sample from the local cache comprises:

if a target data block corresponding to the target sample is not found in the local cache based on mapping between an identifier of the target sample and an identifier of a data block to which the target sample belongs, reading the target data block from a distributed system and storing the target data block in the local cache; and

reading the target sample from the target data block in the local cache.

Reading the target data block from a distributed system and caching it locally makes it possible to reduce the number of times a data block is retrieved from the distributed system, reduce data access costs, and improve data retrieving efficiency.

In a possible implementation of the first aspect, the method further comprises:

clearing the local cache if a number of data blocks in the local cache reaches a threshold.

In this way, it is convenient to cache data blocks retrieved later on.

In a possible implementation of the first aspect, clearing the local cache comprises:

deleting at least one data block in the local cache based on the time of access to data blocks in the local cache, wherein the time of latest access to the at least one data block is earlier than the time of latest access to data blocks in the local cache that are different from the deleted data block.

In this way, it is possible to improve the utilization of data blocks.

In a possible implementation of the first aspect, the method further comprises:

storing in the local cache identifier of each sample, identifier of each data block, and information on position of each sample in the data block.

In this way, it is possible to read the target sample from the cache based on the locally saved information, dispensing with a distributed system, and thereby improve data reading efficiency.

In a possible implementation of the first aspect, the identifier of each sample, the identifier of each data block, and the information on position of each sample in the data block are stored in the form of a mapping.

Storing them in a mapping makes it possible to speed up the search.

In a possible implementation of the first aspect, the plurality of data blocks in the dataset are stored in a distributed system, and the samples includes an image.

A second aspect of the present disclosure provides an apparatus for retrieving samples, the apparatus comprising:

a first shuffling module configured to shuffle a plurality of data blocks in a dataset, wherein each of the plurality of data blocks includes a plurality of samples;

a dividing module configured to divide the plurality of data blocks shuffled by the first shuffling module into a plurality of processing batches;

a second shuffling module configured to shuffle a plurality of samples in a first processing batch among the plurality of processing batches divided by the dividing module, and obtain a sample retrieving order corresponding to the first processing batch; and

a retrieving module configured to retrieve samples in the sample retrieving order corresponding to the first processing batch obtained by the second shuffling module, for the first processing batch.

In a possible implementation of the second aspect, the apparatus further comprises:

a caching module configured to retrieve, before samples are retrieved, a data block to which the samples belong from a distributed system, and store the data block in a local cache.

In a possible implementation of the second aspect, the retrieving module is further configured to:

retrieve samples a plurality of times in the sample retrieving order corresponding to the first processing batch, wherein one or a plurality of samples are retrieved at a time, and a plurality of samples retrieved at a time belong to the same data block.

In a possible implementation of the second aspect, the retrieving module is further configured to:

determine a target sample among a plurality of samples to be retrieved, in the sample retrieving order corresponding to the first processing batch, wherein the target sample is one sample to be retrieved this time; and

read the target sample from the local cache.

In a possible implementation of the second aspect, the apparatus further comprises:

a reading module configured to read, after the target sample is read from the local cache, from the local cache, a sample among the plurality of samples to be retrieved that belongs to the same data block as the target sample.

In a possible implementation of the second aspect, the retrieving module is further configured to:

search for a target data block corresponding to the target sample in the local cache based on a mapping between an identifier of the target sample and an identifier of a data block to which the target sample belongs, and read the target sample from the target data block.

In a possible implementation of the second aspect, the retrieving module is further configured to:

if a target data block corresponding to the target sample is not found in the local cache based on a mapping between an identifier of the target sample and an identifier of a data block to which the target sample belongs, read the target data block from a distributed system and storing the target data block in the local cache; and

read the target sample from the target data block in the local cache.

In a possible implementation of the second aspect, the apparatus further comprises:

a clearing module configured to clear the local cache if a number of data blocks in the local cache reaches a threshold.

In a possible implementation of the second aspect, the clearing module is further configured to:

delete at least one data block in the local cache based on the time of access to data blocks in the local cache, wherein the time of latest access to the at least one data block is earlier than the time of latest access to data blocks in the local cache that are different from the deleted data block.

In a possible implementation of the second aspect, the apparatus further comprises:

a storage module configured to store in the local cache identifier of each sample, identifier of each data block, and information on position of each sample in the data block.

In a possible implementation of the second aspect, the identifier of each sample, the identifier of each data block, and the information on position of each sample in the data block are stored in the form of a mapping.

In a possible implementation of the second aspect, the plurality of data blocks in the dataset are stored in a distributed system, and the samples includes an image.

A third aspect of the present disclosure provides an electronic device comprising: a processor; and a memory for storing instructions executable by the processor, wherein the processor is configured to invoke the instructions stored in the memory to perform the methods described above.

A fourth aspect of the present disclosure provides a computer-readable storage medium storing computer program instructions, which, when executed by a processor, implement the methods described above.

A fifth aspect of the present disclosure provides a computer program comprising computer-readable codes, wherein when the computer-readable codes are run on a device, a processor in the device executes instructions for implementing the methods described above.

In an example of the present disclosure, first, data blocks in a dataset are shuffled, and the shuffled data blocks are divided into a plurality of processing batches, then all samples in one processing batch among the processing batches are shuffled, and a sample retrieving order corresponding to the one processing batch is obtained, and finally samples in the one processing batch are retrieved. Shuffling data blocks and samples in one batch randomizes samples in one batch. Besides, dividing data blocks into processing batches causes samples in one batch to come from a limited number of data blocks, which makes it more likely for adjacent samples in one processing batch to appear in one data block and thereby makes it more likely for data blocks to be found during sample retrieving. As a result, sample retrieving efficiency is improved. The adjacent samples may refer to two samples that are adjacent in a sample retrieving order, or two samples between which there is a small interval in a sample retrieving order, or the like.

It can be appreciated that the above general description and the following detailed description are only exemplary and explanatory, and are not meant to limit the present disclosure. Other features and aspects of the present disclosure will become clear from the following detailed description of exemplary examples with reference to the accompanying drawings.

### BRIEF DESCRIPTION OF THE DRAWINGS

The drawings here are incorporated into and constitute a part of the specification. The drawings show examples consistent with the present disclosure and are used to explain the technical solutions of the present disclosure together with the specification.

FIG. 1 is a flowchart of a method for retrieving samples according to an example of the present disclosure.

FIG. 2 is an exemplary flowchart of a method for retrieving samples according to an example of the present disclosure.

FIG. 3 is a schematic flowchart of retrieving a target sample according to an example of the present disclosure.

FIG. 4 is a schematic diagram of a local cache cleaning process according to an example of the present disclosure.

FIG. 5 is a block diagram of an apparatus for retrieving samples according to an example of the present disclosure.

FIG. 6 is a block diagram of electronic device 800 according to an example of the present disclosure.

FIG. 7 is a block diagram of electronic device 1900 according to an example of the present disclosure.

### DETAILED DESCRIPTION

The following is a detailed description of various exemplary examples, characteristics and aspects of the present disclosure with reference the drawings. The same numeral signs in the drawings denote elements of equal or similar functions. Unless specified otherwise, the drawings are not proportionally drawn.

The word “exemplary” herein means “used as an example or embodiment or for an illustrative purpose.” Any examples described herein as being “exemplary” do not have to be interpreted as being superior to or better than other examples.

The term “and/or” herein just means association between associated objects, which means that three relationships exist between the associated objects. For example, “A and/or B” means the three cases that A exists alone, A and B exist at the same time, B exists alone. Besides, the term “at least one” herein means any one of a plurality things, or any combination of at least two of a plurality of things. For example, “including at least one of A, B, and C” means any one or some elements selected from the set consisting of A, B and C.

In order to better explain the present disclosure, a number of details are given in the following embodiments. It can be appreciated by a person skilled in the art that without some of the details, the present disclosure can still be implemented. In some of the examples, methods, means, components and circuits that are well known to a person skilled in the art are not described in detail in order to highlight the purpose of the present disclosure.

In deep learning, it is usually necessary to use a large number of samples to train the neural network. Samples in a dataset are accessed in a storage system in units of data blocks. That is, when a sample is to be retrieved from a storage system, it is necessary to retrieve first, from the storage system, a data block to which the sample belongs, and then retrieve the sample from the data block.

In the case of requesting a plurality of samples at the same time, reading operations of the plurality of samples can be combined on a block basis. For example, suppose that 1,000 samples are requested at a time. If 10 samples of the 1000 samples come from a certain data block. Then, the 10 samples can be read from the data block in one time after the data block is retrieved, instead of performing the read operation ten times and retrieving the data block once every time the reading operation is performed, resulting in reading the 10 samples in ten times.

As a relevant technology, all samples in a dataset are shuffled, and the shuffled samples are divided into a plurality of processing batches. Subsequently, for each of the processing batches, the samples are retrieved in the order of the samples in the processing batch. In this way, the samples in each of the processing batches are retrieved randomly, thus solving the overfitting problem of the model. In this way, the samples in one processing batch may belong to an arbitrary data block. Thus, in sample retrieving for any one of the processing batches, it is less likely for adjacently retrieved samples to belong to the same data block. Therefore, after one data block is retrieved, only one sample, or a few samples in rare cases, can be retrieved from the one data block, resulting in resource waste, a lower sample retrieving speed and low sample retrieving efficiency.

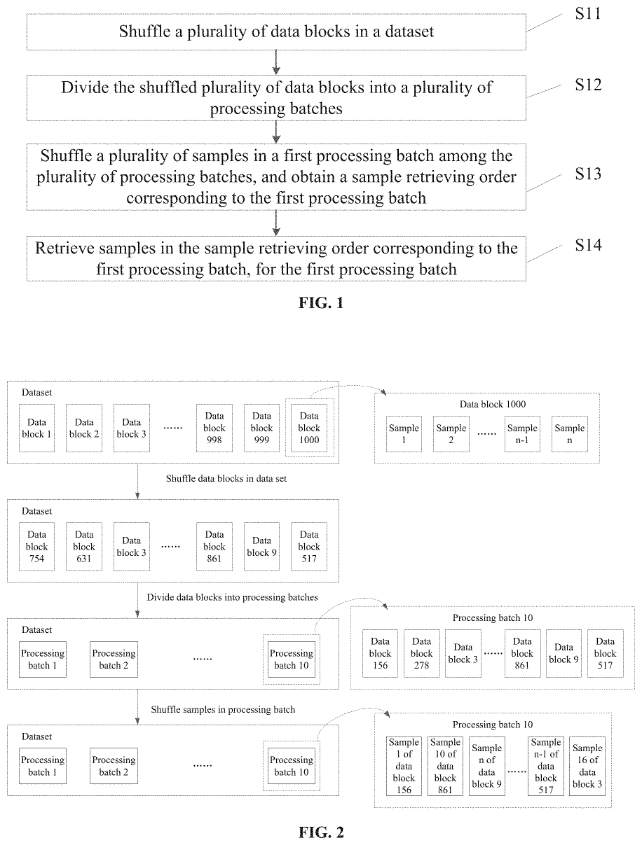

FIG. 1 is a flowchart of a method for retrieving samples according to an example of the present disclosure. As shown in FIG. 1, the method comprises:

Step S11 of shuffling a plurality of data blocks in a dataset, wherein each of the plurality of data blocks includes a plurality of samples;

Step S12 of dividing the plurality of shuffled data blocks into a plurality of processing batches;

Step S13 of shuffling a plurality of samples in a first processing batch among the plurality of processing batches, and obtaining a sample retrieving order corresponding to the first processing batch; and

Step S14 of retrieving samples in the sample retrieving order corresponding to the first processing batch, for the first processing batch.

The first processing batch is a part or each of the plurality of processing batches. In the present disclosure, each of the plurality of processing batches is taken as an example of the first processing batch, but the first processing batch is not limited thereto. The present disclosure can also be applied for the part of the processing batches, the description of which will be omitted here.

In an example of the present disclosure, shuffling data blocks and samples in one batch randomizes samples in one batch. Besides, dividing data blocks into processing batches causes samples in one batch to come from a limited number of data blocks, which makes it more likely for adjacent samples in one processing batch to appear in one data block and thereby makes it more likely for data blocks to be found in sample retrieving. As a result, sample retrieving efficiency is improved.

In a possible implementation, the method for retrieving samples may be performed by an electronic device such as a terminal device or a server. The terminal device may be user equipment (UE), a mobile device, a user terminal, a terminal, a cellular phone, a cordless phone, a personal digital assistant (PDA), a handheld device, a computing device, an in-vehicle device, a wearable device, etc. The method may also be implemented by the processor calling computer-readable instructions stored in the memory, or by a server.

In step S11, the dataset may represent a set of all samples used to train the neural network, a set of all samples used to verify a result of training the neural network, or the like. The samples included in the dataset are located in different data blocks. That is, the dataset comprises a plurality of data blocks, and each of the data blocks comprises a plurality of samples. In a possible implementation, a plurality of data blocks in the dataset may be stored in a distributed system. Samples in the dataset may be accessed in the distributed system in units of file blocks. In this way, a plurality of data blocks can be retrieved in the same time period, that is, data blocks can be retrieved in parallel. This helps to increase the sample retrieving speed. In a possible implementation, the sample may be an image (such as a face image and a human body image, etc.). To take the case that the sample is an image for example, the image's format (jpg, png, etc.), type (such as gray image, RGB (Red-Green-Blue) image, etc.), resolution, and the like are not limited in this example of the present disclosure. Resolution, for example, may be determined according to factors such as the training requirements or verification precision of the model.

Shuffling a plurality of data blocks in a dataset is to perform shuffling processing with data blocks as minimum units. It is the logical order of the data blocks rather than their storage order that is shuffled. After a plurality of data blocks in a dataset are shuffled, the order of the shuffled data blocks is retrieved. When a plurality of data blocks in a dataset is shuffled, the order of samples included in each of the data blocks may be maintained or changed, which is not limited in the present disclosure.

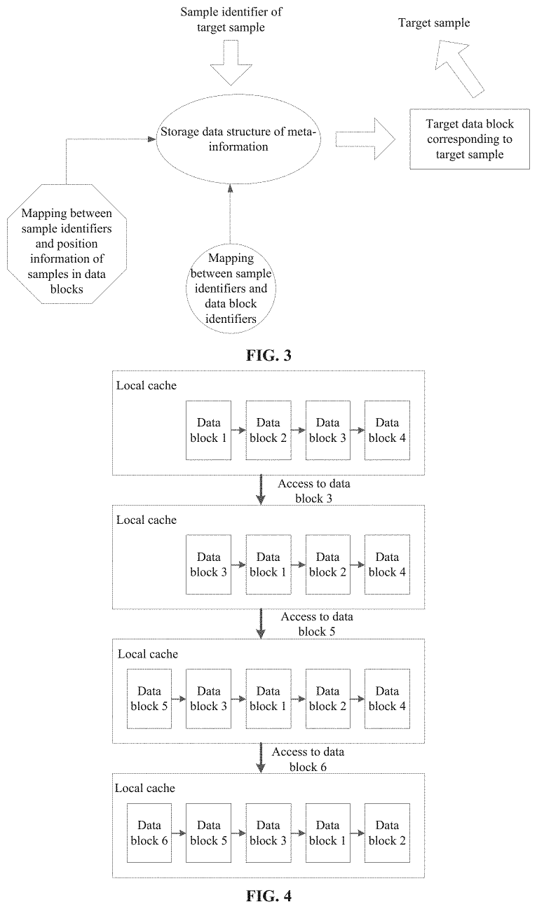

FIG. 2 is an exemplary flowchart of a method for retrieving samples according to an example of the present disclosure. As shown in FIG. 2, the dataset comprises 1,000 data blocks (data block 1, data block 2, data block 3 . . . and data block 1,000), and each of the data blocks comprises a plurality of samples. Data block 1000, for example, comprises n samples (sample 1, sample 2 . . . and sample n, where n is a positive integer). Shuffling the 1,000 data blocks in the dataset results in a logical order of the shuffled data blocks: data block 754, data block 631, data block 3 . . . data block 861, data block 9, and data block 517 in FIG. 2.

In step S12, the shuffled plurality of data blocks are divided into a plurality of processing batches. After the division is completed, each of the processing batches comprises at least one data block.

In an example of the present disclosure, samples in one processing batch may be used for neural network training or neural network verification. For neural network training, for example, each processing batch may comprise samples used for training the neural network once, that is, each processing batch may serve as one training set. Correspondingly, the number of data blocks in each processing batch may be determined according to the number of samples used for training the neural network once and/or the number of samples included in each data block.

For example, in the case where the number of samples included in each data block is the same, the number of data blocks in each processing batch may be the ratio of the number of samples used for training the neural network once to the number of samples included in each data block. In an example, the number of data blocks in each processing batch may be set as needed. An alternative way is to first set the number of samples in one processing batch for training the neural network as needed, and then determine the number of data blocks in each processing batch in accordance with the number of samples used for training the neural network once and the number of samples included in each data block. The present disclosure does not limit that.

It should be noted that, in an actual storage process, the number of samples included in different data blocks may be the same or different. Therefore, in determining the number of data blocks included in each processing batch, the number of data blocks corresponding to at least part of the processing batches may be set to be the same or different. The processing batch dividing method, the number of samples that can be accommodated in a data block, and the like are not limited in examples of the present disclosure.

In an implementation, in the case where the number of data blocks included in each processing batch are the same, and the number of samples included in each data block are also the same, the number of processing batches may be determined in accordance with the total number of data blocks in the dataset and the number of data blocks in each processing batch (i.e., batch size). For example, the number of processing batches may be the ratio of the total number of data blocks in the dataset to the number of data blocks in each processing batch.

Referring to FIG. 2, the total number of data blocks in the dataset is 1,000, and the number of data blocks included in each processing batch is 100; thus, the number of processing batches is 1,000/100=10. This means that for 100 data blocks in each processing batch, the shuffled 1,000 data blocks may be divided into 10 processing batches. FIG. 2 is an example of all data blocks included in processing batch 10 (i.e., the 10th processing batch), which are data block 156, data block 278, data block 3 . . . data block 861, data block 9 and data block 517.

In step S13, a plurality of samples in a first processing batch among the plurality of processing batches may be shuffled, and a sample retrieving order corresponding to the first processing batch is obtained. That is, shuffling processing is performed on the first processing batch with samples as the minimum units.

Referring to FIG. 2, to take the case that processing batch 10 is the first processing batch for example, all the data blocks (data block 156, data block 278, data block 3 . . . and data block 861, data block 9 and data block 517) in the processing batch 10 are shuffled to obtain the sample retrieving order corresponding to processing batch 10.

Steps S11 and S12 ensure that samples to be retrieved that are indicated by the same processing batch (e.g., the first processing batch) are confined to a limited number of data blocks while data blocks are read in random. Step S13 makes it possible to retrieve samples in one processing batch (e.g., the first processing batch) in random. That is to say, steps S11 to S13 not only make it possible to retrieve samples in one processing batch (e.g., the first processing batch) in a random order, but also ensure that samples in one processing batch (e.g., the first processing batch) come from a limited number of data blocks, which makes it more likely for adjacent samples in one processing batch (e.g., the first processing batch) to appear in one data block.

In step S14, for the first processing batch, the samples are retrieved in the sample retrieving order corresponding to the first processing batch. For example, as shown in FIG. 2, for processing batch 10 (when the samples in processing batch 10 are used for training the neural network), the samples in the processing batch 10 can be retrieved in the sample retrieving order corresponding to processing batch 10.

In a possible implementation, the method further comprises, before retrieving samples, retrieving a data block to which the samples belong from a distributed system, and storing the data block in a local cache.

In an example of the present disclosure, a cache area for storing data may be set locally—that is, a local cache is set, such as a cache memory. The local cache may store data blocks retrieved from a distributed system.

Since the samples in one data block belong to the same processing batch, it follows that for a processing batch, a plurality of samples of the processing batch can be retrieved from the same data block. Thus, after a data block retrieved from the distributed system is stored in a local cache, a plurality of samples can be retrieved from the local cache, which reduces the number of times one data block is retrieved from the distributed system, reduces data access costs, and improves data reading efficiency.

In a possible implementation, retrieving samples in the sample retrieving order corresponding to the first processing batch comprises: retrieving samples a plurality of times in the sample retrieving order corresponding to the first processing batch, wherein one or a plurality of samples are retrieved at a time, and the plurality of samples retrieved at a time belong to the same data block.

Since for one processing batch, a plurality of samples of the processing batch can be retrieved from the same data block—that is, a plurality of samples of the first processing batch can be retrieved from the same data block, it follows that in an example of the present disclosure, a plurality of samples belonging to the first processing batch are retrieved from the same data block at a time in the sample retrieving order, thereby improving data retrieving efficiency for the first processing batch.

In a possible implementation, the size of the first processing batch may be large, that is, a large number of samples need to be retrieved for the first processing batch. In this case, samples to be retrieved are grouped in the sample retrieving order corresponding to the first processing batch, and samples are then retrieved in units of groups—that is, samples are retrieved in a plurality of times, and one group of samples may be retrieved at a time (that is, one group of samples may include one or a plurality of samples). In the case of retrieving a plurality of samples at a time, the plurality of samples retrieved at a time belong to the same data block.

For example, suppose that the first processing batch comprises 1,000 samples. Then, the 1,000 samples may be divided into 10 groups in the sample retrieving order. The first group consists of the first to 100th to-be-retrieved samples in the sample retrieving order, the second group consists of the 101st to 200th to-be-retrieved samples in the sample retrieving order . . . and the tenth group consists of the 901th to 1000th to-be-retrieved samples in the sample retrieving order.

The samples in one processing batch come from a limited number of data blocks, so it is more likely for each group of to-be-retrieved samples (i.e., adjacent samples in a processing batch) to come from the same data block. After one data block is retrieved, it is more likely to read samples of the same group from the data block. A plurality of to-be-retrieved samples can thus be retrieved by reading the data block once, which improves data reading efficiency. Besides, grouping samples in one processing batch makes it possible to read a plurality of groups of sample in parallel, which further improves data reading efficiency.

In a possible implementation, the size of the first processing batch may be small, that is, the number of samples to be retrieved for the first processing batch is small. In this case, the samples may be retrieved in a plurality of times without being grouped, and one or a plurality of samples are retrieved at a time. In the case of retrieving a plurality of samples at a time, the retrieved plurality of samples belong to the same data block.

For example, suppose that the first processing batch includes 100 samples. Then, the samples may not be grouped. If the 100 samples come from 2 data blocks, then after one of the data blocks is retrieved, 50 samples are retrieved from the data block at a time. Thus, it is unnecessary to retrieve the same data block repeatedly and thus unnecessary to read samples separately in the course of retrieving the data block a plurality of times. This effectively reduces the number of times that the data block is retrieved and thereby improves data reading efficiency.

It should be noted that in determining the size of a processing batch, one may consider the number of samples involved in the processing batch, or the amount of information included in samples involved in the processing batch. For example, for samples involving complex processing and large amount of information, even if the number of samples involved in processing a batch is small, it can be considered as a large-scale processing batch. In an example of the present disclosure, how to determine the size of a processing batch is not limited, and may include but is not limited to the above-mentioned cases.

Suppose, for example, the size of a processing batch is determined in accordance with the number of samples. Then, by comparing the number of samples in the processing batch with a specified threshold, it can be determined that a size of the processing batch in which the number of samples is greater than the specified threshold is larger, or that a size of the processing batch in which the number of samples is lower than or equal to the specified threshold value is smaller. The specified threshold may be set in advance, and may be set according to factors such as data processing capability and resource occupancy of the apparatus. For example, the specified threshold may be set as 100. An example of the present disclosure does not limit the specified threshold.

It should be noted that, in an example of the present disclosure, it is also possible to retrieve only one sample at a time, rather than retrieving a plurality of samples belonging to the same data block at a time. Since the data block is cached locally, then when samples are to be retrieved from the data block, they can be directly retrieved from the local cache, making it unnecessary to retrieve the data block from the distributed system again. Therefore, even for the case of retrieving only one sample at a time, data reading efficiency is also improved.

In a possible implementation, retrieving samples a plurality of times in the sample retrieving order corresponding to the first processing batch comprises: determining a target sample among a plurality of samples to be retrieved, in the sample retrieving order corresponding to the first processing batch, wherein the target sample is one sample to be retrieved this time; and reading the target sample from the local cache.

The target sample may represent one sample to be retrieved in the sample retrieving order corresponding to the first processing batch. In an example of the present disclosure, after a target sample to be retrieved is determined, the target sample may be read from the local cache. Since it is probable that different samples of the first processing batch are found in one data block, it follows that it is probable to find the data block corresponding to the target sample when the target sample is retrieved, which improves sample retrieving efficiency.

In a possible implementation, the method further comprises, after reading the target sample from the local cache, reading, from the local cache, a sample among the plurality of samples to be retrieved that belongs to the same data block as the target sample, which improve data retrieving efficiency.

Retrieving a target sample indicates that a data block to which the target sample belongs exists in the local cache. Retrieving at a time all the samples to be retrieved that belong to the data block can further save access resources and improve sample retrieving efficiency.

For example, suppose that the target samples to be retrieved are: sample 1 of data block 156, sample 10 of data block 861, sample n of data block 9, sample 50 of data block 156, sample 2 of data block 278, and sample 10 of data block 156. In an example of the present disclosure, after sample 1 of data block 156 (which is the target sample in this case) is retrieved, sample 50 and sample 10 may be retrieved from data block 156—which corresponds to the target sample. In this way, it is no longer necessary to retrieve data from data block 156, so it is no longer necessary to retrieve data block 156, which saves access resources and improves sample retrieving efficiency.

It should be noted that when a plurality of samples are retrieved from one data block at a time, the logical order of the plurality of samples in the processing batch should be consistent with the sample retrieving order corresponding to the processing batch. In this way, the samples in the processing batch are randomized.

When retrieving a target sample, the first step is to determine whether a data block corresponding to the target sample exists in the local cache. If there is a data block corresponding to the target sample in the local cache the target sample is directly retrieved from the data block corresponding to the target sample in the local cache. If the data block corresponding to the target sample does not exist in the local cache, the data block corresponding to the target sample can be retrieved from the distributed system and stored in the local cache. Then, the target sample is retrieved from the locally cached data block corresponding to the target sample. It should be noted that in an actual sample retrieving process, a target sample may first be read from a data block corresponding to the target sample that is retrieved from the distributed system, and then or at the same time, the retrieved data block is stored in the local cache. That is, in an example of the present disclosure, the order of storing a data block and reading the target sample from the data block is not limited.

In an example, reading the target sample from the local cache comprises: searching for a target data block corresponding to the target sample in the local cache based on a mapping between an identifier of the target sample and an identifier of a data block to which the target sample belongs, and reading the target sample from the target data block.

In an example, reading the target sample from the local cache comprises: if a target data block corresponding to the target sample is not found in the local cache based on a mapping between an identifier of the target sample and an identifier of a data block to which the target sample belongs, reading the target data block from a distributed system and caching it locally; and reading the target sample from the locally cached target data block.

In an example of the present disclosure, an identifier of each sample, an identifier of each data block, and information on a position of each sample in a data block may be stored locally in advance. In this way, when a target sample is to be read, it is possible to determine a target data block corresponding to the target sample and a storage location of the target sample in the target data block based on the locally saved information and thus possible to read the target sample from the cache based on the locally saved information. It is thereby no longer necessary to read the target sample based on the information stored in the distributed system, which improves data reading efficiency.

In a possible implementation, the identifier of each sample, the identifier of each data block, and the information on a position of each sample in a data block are stored in the form of a mapping.

In an example, the mapping between the identifier of each sample and the identifier of each data block as well as the mapping between the identifier of each sample and the information on a position of each sample in a data block are stored locally.

From the mapping between the identifier of each sample and the identifier of each data block, it is possible to determine a data block identifier corresponding to the identifier of the target sample; from the determined data block identifier, it is possible to find a data block corresponding to the target sample in the local cache.

From the mapping between the identifier of each sample and the information on a position of each sample in a data block, it is possible to determine position information corresponding to the identifier of the target sample; from the determined position information, it is possible to retrieve the target sample from a data block corresponding to the target sample.

An identifier of a sample may be used to identify the sample, and different samples have different identifiers. In an example of the present disclosure, an identifier of a sample may be the name of the sample, the number of the sample, or the like. An identifier of a data block may be used to identify the data block, and different data blocks have different identifiers. In an example of the present disclosure, an identifier of a data block may be the name of the data block, the number of the data block, or the like. In an example of the present disclosure, how to generate an identifier of a sample and an identifier of a data bock is not limited.

It should be noted that an identifier of each sample, an identifier of each data block, and information on a position of each sample in a data block may also be stored in other forms, and do not have to be stored in the above-mentioned mapping form or in the form of the above-mentioned specific information.

In another example, an identifier of a sample, an identifier of a data block, and information on a position of a sample in a data block may be stored in a meta-information storage data structure, which can be set as a key-value form. An identifier of a sample may be stored as a key, and an identifier of a data block as well as information on a position of a sample in a data block may be stored as a value. From the meta-information storage data structure, it is possible to determine the correspondence between an identifier of a sample and an identifier of a data block as well as the correspondence between an identifier of a sample and information on a position of a sample in a data block.

FIG. 3 is a schematic flowchart of retrieving a target sample according to an example of the present disclosure. As shown in FIG. 3, as an example, an identifier of each sample, an identifier of each data block, and information on a position of each sample in a data block are stored in the form of a mapping. To retrieve a target sample, a data block identifier corresponding to a training identifier of the target sample is determined from the mapping between the sample identifiers and the data block identifiers in the meta-information storage data structure; a data block corresponding to the target sample is determined from the determined data block identifier; the mapping between the sample identifiers and the information on positions of the samples in the data blocks is determined from the meta-information storage data structure; the information on the position of the target sample in the data block corresponding to the target sample is determined; and the target sample is retrieved from the data block corresponding to the target sample based on the determined information on the position.

Locally storing the mapping between sample identifiers and data block identifiers, and the mapping between sample identifiers and position information of samples in data blocks makes it possible to retrieve a target sample to be retrieved only by local access after determining the target sample, which further improves sample retrieving efficiency.

It should be noted that, before step S1, the mapping between sample identifiers and data block identifiers as well as the mapping between sample identifiers and position information of samples in data blocks may be retrieved from a distributed system and stored locally.

The number of data blocks that the local cache can store, that is, the size of the local cache, may be set as needed. Since a local cache can only accommodate a limited number of data blocks, in order for new data blocks retrieved from a distributed storage system to be stored in the local cache, whether to clear the local cache can be determined according to occupancies of the local cache.

When the number of data blocks stored in the local cache reaches a threshold (e.g., 80% or 100% of the cache size of the local cache), the local cache needs to be cleared. In an example, when the number of data blocks in the local cache reaches the threshold, the local cache is directly cleared, so that enough space is reserved for data blocks that need to be retrieved next time. In another example, when the number of data blocks in the local cache is detected to reach the threshold, and then a new data block is retrieved (for example, a data block that is needed but does not exist in the local cache is retrieved from a distributed system), the local cache is cleared. In this way, when the local cache is full, and a sample is still needed to be retrieved next time from a locally cached data block, the data block that has just been deleted from the local cache does not have to be retrieved from the distributed storage system. Consequently, the resources consumed by data block retrieving are saved, less time is needed to retrieve samples from the data block, and thus data reading efficiency is improved.

In a possible implementation, clearing the local cache comprises: deleting at least one data block in the local cache based on the time of access to data blocks in the local cache, wherein the time of latest access to the at least one data block is earlier than the time of latest access to data blocks in the local cache that are different from the deleted data block.

In an example of the present disclosure, the access situation of each data block in the local cache may be recorded for the purpose that when the local cache is to be cleared later on, the data blocks that have not been accessed for a long time may be preferentially cleared and the data blocks that have been accessed recently are retained. This reduces the chance that a data block needs to be retrieved from the distributed storage system immediately after the date block is cleared, thereby reducing the number of accesses to the distributed storage system, and further improving sample retrieving efficiency.

During the clearing of the local cache, one or a plurality of data blocks may be deleted at a time, depending on factors such as the access situation of the data blocks or the situation of the data blocks to be cached. In an example of the present disclosure, the number of data blocks deleted each time when the local cache is cleared, the deletion mechanism, and the like are not limited, and may include but are not limited to the situations exemplified above.

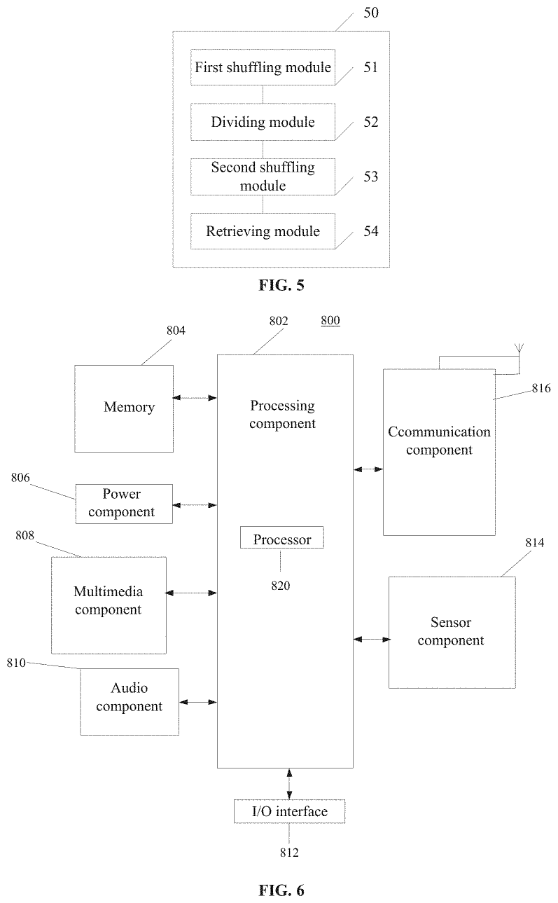

FIG. 4 is a schematic diagram of a local cache cleaning process according to an example of the present disclosure. Suppose that the number of data blocks that the local cache can accommodate is 5, that is, the threshold is 5, which means that when the number of data blocks stored in the local cache reaches 5, the local cache needs to be cleared. As shown in FIG. 4, data block 1, data block 2, data block 3, and data block 4 are stored in the local cache; the time of latest access to data block 4 is earlier than the time of latest access to data block 3, the time of latest access to data block 3 is earlier than the time of latest access to data block 2, and the time of latest access to data block 2 is earlier than the time of latest access to data block 1. That is to say, the data blocks currently stored in the local cache are data block 1, data block 2, data block 3, and data block 4 in an ascending order of time interval from the time of latest access to the current time.

As shown in FIG. 4, when a target sample is to be retrieved from data block 3, since data block 3 exists in the local cache, the target sample can be retrieved by accessing data block 3 in the local cache. At this point, the interval from the latest access time of data block 3 to the current time becomes smaller than the interval from the latest access time of other data blocks (data block 1, data block 2, and data block 4) to the current time. The data blocks currently stored in the local cache are data block 3, data block 1, data block 2, and data block 4 in an ascending order of time interval from the time of latest access to the current time.

After that, when a target sample is to be retrieved from data block 5, since data block 5 is not stored in the local cache, it is necessary to retrieve data block 5 from a distributed system. Since the number of data blocks currently stored in the local cache is 4, smaller than 5 which is the threshold of the local cache, data block 5 may be stored directly in the local cache after being retrieved from the distributed system. Then, the target sample is retrieved by accessing data block 5 in the local cache. At this point, the interval from the latest access time of data block 5 to the current time becomes smaller than the interval from the latest access time of other data blocks (data block 3, data block 1, data block 2, and data block 4) to the current time. The data blocks currently stored in the local cache are data block 5, data block 3, data block 1, data block 2, and data block 4 in an ascending order of time interval from the time of latest access to the current time.

Next, when a target sample is to be retrieved from data block 6, since data block 6 is not stored in the local cache, it is necessary to retrieve data block 6 from a distributed system. Since the number of data blocks currently stored in the local cache is 5, equal to the threshold of the local cache, the local cache has to be cleaned first. For example, data block 4, whose latest access time is earlier than the latest access time of the other data blocks (data block 3, data block 1, and data block 2), may be deleted. After the cleaning is completed, data block 6 retrieved from the distributed system is stored in the local cache. At this point, the interval from the latest access time of data block 6 to the current time becomes smaller than the interval from the latest access time of other data blocks (data block 5, data block 3, data block 1, and data block 2) to the current time. The data blocks currently stored in the local cache are data block 6, data block 5, data block 3, data block 1 and data block 2 in an ascending order of time interval from the time of latest access to the current time.

It can be appreciated that the examples of the methods of the present disclosure described above can be combined with each other to form a combined example, provided that such combination does not depart from the logical principle of the present disclosure. No more details in this regard are provided in the present disclosure in order for the present disclosure not to be unduly long. It can be appreciated by a person skilled in the art that in the examples of the methods of the present disclosure described above, the order of the steps should be determined by their functions and possible inherent logic.

Also, the present disclosure also provides an apparatus, electronic device, computer-readable storage medium, and program for retrieving samples, all of which can be used to implement any of the methods for retrieving samples provided by the present disclosure. For more details of the corresponding technical solutions and description, see the above description of the methods.

FIG. 5 is a block diagram of an apparatus for retrieving samples according to an example of the present disclosure. As shown in FIG. 5, apparatus 50 comprises:

first shuffling module 51 to shuffle a plurality of data blocks in a dataset, wherein each of the plurality of data blocks includes a plurality of samples;

dividing module 52 to divide the plurality of data blocks shuffled by first shuffling module 51 into a plurality of processing batches;

second shuffling module 53 to shuffle a plurality of samples in a first processing batch among the plurality of processing batches divided by dividing module 52, and obtain in a sample retrieving order corresponding to the first processing batch; and

retrieving module 54 to retrieve samples in the sample retrieving order corresponding to the first processing batch obtained by second shuffling module 53, for the first processing batch.

In an example of the present disclosure, shuffling data blocks and samples in one batch randomizes samples in one batch. Besides, dividing data blocks into processing batches causes samples in one batch to come from a limited number of data blocks, which makes it more likely for adjacent samples in one processing batch to appear in one data block and thereby makes it more likely for data blocks to be found in sample retrieving. As a result, sample retrieving efficiency is improved.

In a possible implementation, the apparatus further comprises: a caching module to retrieve, before samples are retrieved, a data block to which the samples belong from a distributed system and cache it locally.

In a possible implementation, retrieving module 54 is further to: retrieve samples a plurality of times in the sample retrieving order corresponding to the first processing batch, wherein one or a plurality of samples are retrieved at a time, and a plurality of samples retrieved at a time belong to the same data block.

In a possible implementation, retrieving module 54 is further to: determine a target sample among a plurality of samples to be retrieved, in the sample retrieving order corresponding to the first processing batch, wherein the target sample is one sample to be retrieved this time; and read the target sample from the local cache.

In a possible implementation, apparatus 50 further comprises: a reading module to read, after the target sample is read from the local cache, from the local cache, a sample among the plurality of samples to be retrieved that belongs to the same data block as the target sample.

In a possible implementation, retrieving module 54 is further to: search for a target data block corresponding to the target sample in the local cache based on a mapping between an identifier of the target sample and an identifier of a data block to which the target sample belongs, and read the target sample from the target data block.

In a possible implementation, retrieving module 54 is further to: if a target data block corresponding to the target sample is not found in the local cache based on a mapping between an identifier of the target sample and an identifier of a data block to which the target sample belongs, read the target data block from a distributed system and cache it locally; and read the target sample from the locally cached target data block.

In a possible implementation, apparatus 50 further comprises: a clearing module to clear the local cache when the number of data blocks in the local cache reaches a threshold.

In a possible implementation, the clearing module is further to: delete at least one data block in the local cache based on the time of access to data blocks in the local cache, wherein the time of latest access to the at least one data block is earlier than the time of latest access to data blocks in the local cache that are different from the deleted data block.

In a possible implementation, apparatus 50 further comprises: a storage module to locally store identifier of each sample, identifier of each data block, and information on position of each sample in the data block.

In a possible implementation, the identifier of each sample, the identifier of each data block, and the information on position of each sample in the data block are stored in the form of a mapping.

In a possible implementation, the plurality of data blocks in the dataset are stored in a distributed system, and the samples includes an image.

In some examples of the present disclosure, the functions of the apparatuses provided by examples of the present disclosure or the modules contained therein may be used to perform the methods described in the foregoing method examples. See the foregoing method examples, for more details of how to implement those methods.

An example of the present disclosure provides a computer-readable storage medium on which to store computer program instructions, which, when executed by a processor, implement the methods described above. The computer-readable storage medium may be a non-transitory computer-readable storage medium.

An example of the present disclosure provides an electronic device comprising: a processor; and a memory for storing instructions executable by the processor, wherein the processor is to call the instructions stored in the memory to perform the methods described above.

An example of the present disclosure provides a computer program product comprising computer-readable codes, wherein when the computer-readable codes are run on a device, a processor in the device executes instructions for implementing the method provided by any one of the examples described above.

An example of the present disclosure provides another computer program product for storing computer-readable instructions, wherein when the instructions are executed, a computer performs operations of the method for retrieving samples provided by any one of the examples described above.

The electronic device may be provided as a terminal, a server or a device in a different form.

FIG. 6 is a block diagram of electronic device 800 according to an example of the present disclosure. For example, electronic device 800 may be a mobile phone, a computer, a digital broadcasting terminal, a messaging device, a game console, a tablet device medical equipment, fitness equipment, a personal digital assistant, and the like.

Referring to FIG. 6, electronic device 800 includes one or more of processing component 802, memory 804, power component 806, multimedia component 808, audio component 810, input/output (I/O) interface 812, sensor component 814, and communication component 816.

Processing component 802 is to control overall operations of electronic device 800, such as the operations associated with display, telephone calls, data communications, camera operations, and recording operations. Processing component 802 can include one or more processors 820 configured to execute instructions to perform all or part of the steps included in the above-described methods. Processing component 802 may include one or more modules configured to facilitate the interaction between the processing component 802 and other components. For example, processing component 802 may include a multimedia module configured to facilitate the interaction between multimedia component 808 and processing component 802.

Memory 804 is configured to store various types of data to support the operation of electronic device 800. Examples of such data include instructions for any applications or methods operated on or performed by electronic device 800, contact data, phonebook data, messages, pictures, video, etc. In an example of the present disclosure, memory 804 may be used to store data blocks, mappings, or other things retrieved from a distributed system. Memory 804 may be implemented using any type of volatile or non-transitory memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power component 806 is configured to provide power to various components of electronic device 800. Power component 806 may include a power management system, one or more power sources, and any other components associated with the generation, management, and distribution of power in electronic device 800.

Multimedia component 808 includes a screen providing an output interface between electronic device 800 and the user. In some examples, the screen may include a liquid crystal display (LCD) and a touch panel (TP). If the screen includes the touch panel, the screen may be implemented as a touch screen to receive input signals from the user. The touch panel may include one or more touch sensors configured to sense touches, swipes, and gestures on the touch panel. The touch sensors may sense not only a boundary of a touch or swipe operation, but also a period of time and a pressure associated with the touch or swipe operation. In some examples, multimedia component 808 may include a front camera and/or a rear camera. The front camera and the rear camera may receive an external multimedia datum while electronic device 800 is in an operation mode, such as a photographing mode or a video mode. Each of the front camera and the rear camera may be a fixed optical lens system or may have focus and/or optical zoom capabilities.

Audio component 810 is configured to output and/or input audio signals. For example, audio component 810 may include a microphone (MIC) configured to receive an external audio signal when electronic device 800 is in an operation mode, such as a call mode, a recording mode, and a voice recognition mode. The received audio signal may be further stored in memory 804 or transmitted via communication component 816. In some examples, audio component 810 further includes a speaker configured to output audio signals.

I/O interface 812 is configured to provide an interface between processing component 802 and peripheral interface modules, such as a keyboard, a click wheel, buttons, and the like. The buttons may include, but are not limited to, a home button, a volume button, a starting button, and a locking button.

Sensor component 814 may include one or more sensors configured to provide status assessments of various aspects of electronic device 800. For example, sensor component 814 may detect an open/closed status of electronic device 800, relative positioning of components which are e.g., the display and the keypad of electronic device 800, a change in position of electronic device 800 or a component of electronic device 800, a presence or absence of user contact with electronic device 800, an orientation or an acceleration/deceleration of electronic device 800, and a change in temperature of electronic device 800. Sensor component 814 may include a proximity sensor configured to detect the presence of nearby objects without any physical contact. Sensor component 814 may also include a light sensor, such as a complementary metal oxide semiconductor (CMOS) or charge-coupled device (CCD) image sensor, for use in imaging applications. In some examples, sensor component 814 may also include an accelerometer sensor, a gyroscope sensor, a magnetic sensor, a pressure sensor, or a temperature sensor.

Communication component 816 is configured to facilitate wired or wireless communication between electronic device 800 and other devices. Electronic device 800 can access a wireless network based on a communication standard, such as WiFi, 2G, or 3G, 4G, or a combination thereof. In an exemplary example, communication component 816 receives a broadcast signal or broadcast associated information from an external broadcast management system via a broadcast channel. In an exemplary example, communication component 816 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In an exemplary example, electronic device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an exemplary example, there is also provided a non-transitory computer readable storage medium such as memory 804 storing instructions executable by processor 820 of electronic device 800, for performing the above-described methods.

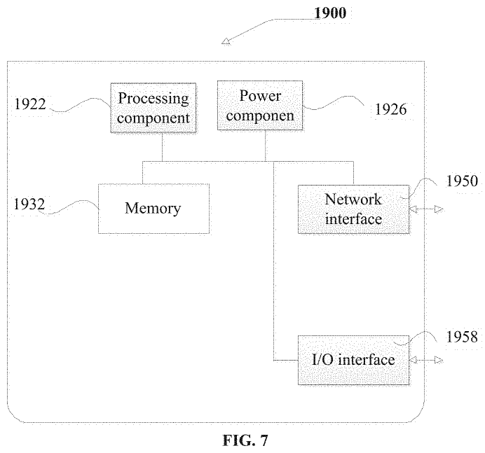

FIG. 7 is a block diagram of electronic device 1900 according to an example of the present disclosure. For example, electronic device 1900 may be provided as a server. Referring to FIG. 7, electronic device 1900 includes processing component 1922, which further includes one or more processors, and a memory resource represented by memory 1932 configured to store instructions such as application programs executable for processing component 1922. The application programs stored in memory 1932 may include one or more than one module of which each corresponds to a set of instructions. In addition, processing component 1922 is configured to execute the instructions to execute the abovementioned methods.

Electronic device 1900 may further include power component 1926 configured to execute power management of electronic device 1900, wired or wireless network interface 1950 configured to connect electronic device 1900 to a network, Input/Output (I/O) interface 1958. Electronic device 1900 may be operated on the basis of an operating system stored in the memory 1932, such as Windows Server™, Mac OS X™, Unix™, Linux™ or FreeBSD™.

In an exemplary example, there is also provided a non-transitory computer readable storage medium such as memory 1932 storing instructions executable by processing component 1922 of apparatus 1900, for performing the above-described methods.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry such as programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the present disclosure. It can be appreciated that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/operations specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the functions/operations specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/operations specified in the flowchart and/or block diagram block or blocks.

The flowchart and block diagrams in drawings illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur in an order different from that noted in the figures. For example, two blocks shown in succession may, in fact, be executed substantially concurrently, or the blocks may sometimes be executed in the reverse order, depending upon the functionality involved. It should also be noted that each block of the block diagrams and/or flowchart illustration, and combinations of blocks in the block diagrams and/or flowchart illustration, can be implemented by special purpose hardware-based systems that perform the specified functions or operations, or combinations of special purpose hardware and computer instructions.

The computer program product may be implemented in hardware, software, or a combination thereof. In an optional example, the computer program product is embodied as a computer storage medium, and in another optional example, the computer program product is embodied as a software product, such as a software development kit (SDK), etc.

Various examples of the present disclosure have been described above. The above description is exemplary, not exhaustive. The present disclosure is not limited to those examples Modifications and variations without departing from the scope and spirit of the examples will be apparent to a person skilled in the art. The terms used herein are intended to best explain the principles and practical applications of the examples and explain how they improve on the techniques on the market, or to enable persons other than a person skilled in the art to understand the examples.

What is claimed is:

1. A method for retrieving samples, comprising:
shuffling a plurality of data blocks in a dataset, each of the plurality of data blocks including a plurality of samples;
dividing the shuffled plurality of data blocks into a plurality of processing batches;
shuffling a plurality of samples in a first processing batch among the plurality of processing batches, and obtaining a sample retrieving order corresponding to the first processing batch; and
retrieving samples in the sample retrieving order corresponding to the first processing batch, for the first processing batch.

2. The method according to claim 1, further comprising, before retrieving samples:
retrieving a data block to which the samples belong from a distributed system and storing the data block in a local cache.

3. The method according to claim 1, wherein retrieving samples in the sample retrieving order corresponding to the first processing batch comprises:
retrieving samples in a plurality of times in the sample retrieving order corresponding to the first processing batch, wherein one or a plurality of samples are retrieved at a time, and a plurality of samples retrieved at a time belong to the same data block.

4. The method according to claim 3, wherein retrieving samples in a plurality of times in the sample retrieving order corresponding to the first processing batch comprises:
determining a target sample among a plurality of samples to be retrieved, in the sample retrieving order corresponding to the first processing batch, the target sample being one sample to be retrieved this time; and
reading the target sample from the local cache.

5. The method according to claim 4, further comprising, after reading the target sample from the local cache:
reading, from the local cache, a sample among the plurality of samples to be retrieved that belongs to the same data block as the target sample.

6. The method according to claim 4, wherein reading the target sample from the local cache comprises:
searching for a target data block corresponding to the target sample in the local cache based on a mapping between an identifier of the target sample and an identifier of a data block to which the target sample belongs, and reading the target sample from the target data block.

7. The method according to claim 4, wherein reading the target sample from the local cache comprises:
if a target data block corresponding to the target sample is not found in the local cache based on a mapping between an identifier of the target sample and an identifier of a data block to which the target sample belongs, reading the target data block from a distributed system and storing the target data block in the local cache; and
reading the target sample from the target data block in the local cache.

8. The method according to claim 2, further comprising:
clearing the local cache if a number of data blocks in the local cache reaches a threshold.

9. The method according to claim 8, wherein clearing the local cache comprises:
deleting at least one data block in the local cache based on a time of access to data blocks in the local cache, wherein the time of latest access to the at least one data block is earlier than the time of latest access to data blocks in the local cache that are different from the deleted data block.

10. The method according to claim 1, further comprising:
storing in the local cache identifier of each sample, identifier of each data block, and information on position of each sample in the data block.

11. The method according to claim 10, wherein the identifier of each sample, the identifier of each data block, and the information on position of each sample in the data block are stored in the form of a mapping.

12. The method according to claim 1, wherein the plurality of data blocks in the dataset are stored in a distributed system, and the samples includes an image.

13. An electronic device, comprising:
a processor; and
a memory for storing instructions executable by the processor,
wherein the processor is configured to invoke the instructions stored in the memory, so as to:
shuffle a plurality of data blocks in a dataset, each of the plurality of data blocks including a plurality of samples;
divide the plurality of shuffled data blocks into a plurality of processing batches;
shuffle a plurality of samples in a first processing batch among the plurality of processing batches, and obtain a sample retrieving order corresponding to the first processing batch; and
retrieve samples in the sample retrieving order corresponding to the first processing batch, for the first processing batch.

14. The electronic device according to claim 13, the processor is further configured to:
retrieve, before samples are retrieved, a data block to which the samples belong from a distributed system, and store the data block in a local cache.

15. The electronic device according to claim 13, wherein retrieving samples in the sample retrieving order corresponding to the first processing batch comprises:
retrieving samples in a plurality of times in the sample retrieving order corresponding to the first processing batch, wherein one or a plurality of samples are retrieved at a time, and a plurality of samples retrieved at a time belong to the same data block.

16. The electronic device according to claim 15, wherein retrieving samples in a plurality of times in the sample retrieving order corresponding to the first processing batch comprises:
determining a target sample among a plurality of samples to be retrieved, in the sample retrieving order corresponding to the first processing batch, the target sample being one sample to be retrieved this time; and
reading the target sample from the local cache.

17. The electronic device according to claim 16, the processor is further configured to:
read, after the target sample is read from the local cache, from the local cache, a sample among the plurality of samples to be retrieved that belongs to the same data block as the target sample.

18. The electronic device according to claim 16, wherein reading the target sample from the local cache comprises:
searching for a target data block corresponding to the target sample in the local cache based on a mapping between an identifier of the target sample and an identifier of a data block to which the target sample belongs, and reading the target sample from the target data block.

19. The electronic device according to claim 16, wherein reading the target sample from the local cache comprises:
if a target data block corresponding to the target sample is not found in the local cache based on a mapping between an identifier of the target sample and an identifier of a data block to which the target sample belongs, reading the target data block from a distributed system and storing the target data block in the local cache; and
reading the target sample from the target data block in the local cache.

20. A non-transitory computer-readable storage medium storing computer program instructions, which, when executed by a processor, causes the processor to perform the operations of:
shuffling a plurality of data blocks in a dataset, each of the plurality of data blocks including a plurality of samples;
dividing the shuffled plurality of data blocks into a plurality of processing batches;
shuffling a plurality of samples in a first processing batch among the plurality of processing batches, and obtaining a sample retrieving order corresponding to the first processing batch; and
retrieving samples in the sample retrieving order corresponding to the first processing batch, for the first processing batch.
